(19) United States
(12) Patent Application Publication
(10) Pub. No.: US 2025/0271548 A1
(43) Pub. Date: Aug. 28, 2025

(54) Methods and Systems for Calibrating a Process for Locating Devices

(71) Applicant: GUANGDONG OPPO MOBILE TELECOMMUNICATIONS CORP., LTD., Dongguan (CN)

(72) Inventor: Yinan QI, Dongguan (CN)

(21) Appl. No.: 19/204,878

(22) Filed: May 12, 2025

Related U.S. Application Data
(63) Continuation of application No. PCT/CN2022/132984, filed on Nov. 18, 2022.

(51) Int. Cl. G01S 7/40; G01S 13/46

(52) U.S. Cl. CPC G01S 7/40; G01S 13/46; G01S 2013/468

(57) ABSTRACT

A method for calibrating a positioning system includes: transmitting a calibration signal from a calibration device at a first known location, receiving, by the calibration device, a reflection of the calibration signal from a locating element at a second known location, wherein the reflection carries identification information of the locating element, analysing, using the first known location and the second known location, a characteristic of the reflection to determine a reflective property of the locating element; and storing calibration information comprising the reflective property of the locating element for use during a process for locating a user device.

### CROSS-REFERENCE TO RELATED APPLICATION

This application is a Continuation Application of International Application No. PCT/CN2022/132984 filed Nov. 18, 2022, which is incorporated herein by reference in its entirety.

### TECHNICAL FIELD

The present application relates to the field of device location, and more particular to calibrating a method and system for locating devices using reflected electromagnetic signals.

### BACKGROUND

Various techniques exist for identifying the location of end-user mobile devices, or user equipment (UE). Such devices may include mobile telephones, laptop computers, tablet computers or other devices connected to a mobile telecommunications system.

In particular, timing, angle and carrier phase based positioning methods have been used in Wi-FI, 4G, 5G and global network satellite system (GNSS). Such methods may include the transmission of signals from base stations or other server-side devices to the UE, and subsequent processing to infer from those signals the position of the UE relative to the transmitting devices.

In some processes, unpowered or low-power tags have been used to provide the positioning signals. For example radio frequency identification (RFID) tags may be used. Such tags may be ambient power (AMP) tags, i.e. tags which have no external power supply but draw energy from the ambient environment, such as through solar power. Tags of this kind have particular advantages in that they may be flexibly deployed without restrictions as to power source, thus facilitating the provision of location services in areas which might otherwise be poorly served by other signal types. For example, GNSS-based positioning may be difficult within buildings, and it may not always be possible to obtain sufficient cellular signals to accurately locate a UE.

The flexibility of AMP tags therefore can provide significant advantages, but the requirement to minimise any power usage presents challenges to convention positioning techniques. In particular, AMP tags may not be able to transmit a wideband positioning reference signal (PRS). As a result, timing based positioning methods, such as Observed Time Difference Of Arrival (OTDOA), may not achieve satisfactory positioning accuracy.

For the same reason, angle based positioning is also not applicable since AMP tags can neither accurately measure the angle of incoming signal nor transmit/reflect a fairly directional signal to the UE.

It has been proposed to use carrier phase based positioning with AMP tags. Beneficially, this technique does not require a wide frequency band to achieve theoretical high positioning accuracy. However, challenges exist in accurately inferring distance from the measured phase.

There remains a need to improve the ability to implement location or positioning techniques in order that they may be utilises low or no-power tags such as AMP tags, thereby improving the ability to obtain the benefits of flexible deployment of such tags while maintaining accuracy and reliability.

### SUMMARY

Embodiments of the present application provide a method and a system for locating a mobile device.

According to an aspect, there is provided a method for calibrating a positioning system. The method includes transmitting a calibration signal from a calibration device at a first known location. A reflection of the calibration signal is then received by the calibration device from a locating element at a second known location, the reflection carrying identification information of the locating element. Using the first known location and the second known location, a characteristic of the reflection is analysed to determine a reflective property of the locating element. Calibration information is stored comprising the reflective property of the locating element for use during a process for locating a user device.

According to a second aspect, there is provided a method for locating a user device. The method comprises transmitting a locating signal from the user device to a plurality of locating elements, each having a known location. Reflections of the locating signal are then received from the locating elements at the user device. Each reflection of the locating signal carries identification information of the locating element from which it was reflected. Distances are calculated between the user device and the locating elements based on characteristics of the reflections received from the locating elements and calibration information obtained through the method of the first aspect. The location of the user device is then identified based on the calculated distances and the known locations.

According to a third aspect there is provided a calibration system comprising a calibration device at a first known location, a locating element at a second location, and a server. A calibration signal is transmitted from the calibration device to the locating element. The calibration device then receives a reflection of the calibration signal from a locating element, the reflection carrying identification information of the locating element. The calibration device or the server may then analyse, using the first known location and the second known location, a characteristic of the reflection to determine a reflective property of the locating element. Calibration information comprising the reflective property of the locating element is then stored at the server for use during a process for locating a user device.

These and other aspects of the present application may become more readily apparent from the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the scope of protection.

### BRIEF DESCRIPTION OF THE DRAWINGS

Embodiments will now be described, by way of example only, with reference to the accompanying drawings, in which:

FIG. 1 illustrates a calibration system for obtaining calibration information for use in a process of locating a device;

FIG. 2 illustrates an embodiment in which a calibration device is implemented as a fixed signal generator;

FIG. 3 illustrates an embodiment in which a calibration device is implemented as a mobile signal generator;

FIG. 4 illustrates an embodiment in which a calibration device is implemented as a user equipment;

FIG. 5 shows a process for obtaining calibration information according to an embodiment;

FIG. 6 illustrates devices which may be used in a process for locating a device; and

FIGS. 7A and 7B show processes for locating a device using the calibration information.

### DETAILED DESCRIPTION

Technical solutions in the embodiments of the present application will be described clearly and completely below with reference to the accompanying drawings.

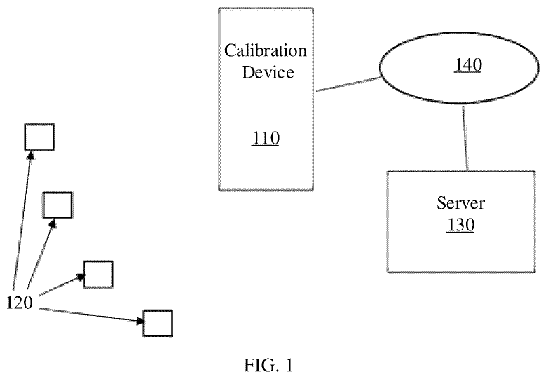

FIG. 1 illustrates a calibration system used to obtain calibration information that can be used to calibrate the operation of a positioning system. The calibration system comprises a calibration device 110, a plurality of locating elements 120 and a server 130.

The calibration device 110 may be coupled to the server 130 via a network 140. For example, a network link may provide data communication through one or more networks between the calibration device 110 and the server 130. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet can both use electrical, electromagnetic or optical signals that carry digital data streams.

The calibration device 110 is configured to generate a calibration signal. The calibration signal may be a wireless signal, such as a Bluetooth signal. The calibration signal may be an electromagnetic signal. The calibration device 110 is capable of receiving a signal of this type and identifying data from it, together with identifying characteristics such as the phase and timing of the signal.

The locating elements 120 may be ambient power (AMP) tags such as RFID tags, configured reflect incoming signals with identification information identifying the individual elements. Accordingly, when a calibration signal from the calibration device 110 is incident upon a locating element 120 it may be reflected and that reflection may be received by the calibration device 110. Since the reflection from the locating element 120 includes identification information of the locating element 120, the calibration device 110 may identify the origin of the reflection.

Each locating element 120 has a known location that may be stored at the server 130 and/or elsewhere, such as by the calibration device 110. Moreover, the location of the calibration device 110 is known. As such, when a reflection is received from a locating element 120 at the calibration device 110, an inference can be made about one or more reflective properties of the locating element 120, as will be discussed in further detail below.

The calibration device 110 may be implemented in any suitable technical form. It may be stationary or mobile. It may be a general purpose computing device with one or more further functions beyond the process of calibration, such as a desktop or laptop computer, a tablet computer or any other device. It may be a terminal device such as a user equipment (UE), an access terminal, a subscriber unit, a subscriber station, a mobile station, a remote station, a remote terminal, a mobile device, a user terminal, a terminal, a wireless communication device, a user agent, or a user apparatus. However, the embodiments of the present application are not limited thereto.

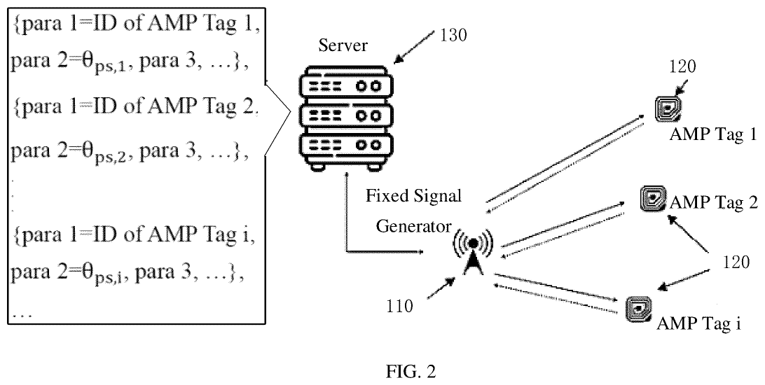

FIGS. 2 to 4 illustrate particular embodiments of the calibration system 100 in which the calibration device 110 takes certain forms.

In the embodiment of FIG. 2, the calibration device 110 is implemented as a fixed signal generator (FSG). Fixed mobile signal generators may generate the same signal as a terminal device or UE in a network, i.e., the same waveform, signal structure, carrier frequency, etc., can be deployed within the entire area where positioning service is provided. These signal generators 110 may also have the phase measurement capability and are connected to a server 130, where all location element 120 (AMP tag related) information is stored as illustrated in FIG. 2. FIG. 2 also schematically illustrates a data structure 200 recorded on the service, where each row {para 1=ID of AMP Tag i, para 2=θps,i, para 3, . . . } is denoted as AMP tag information vector and contains parameters to be used in positioning as described below.

The use of an FSG 110 as the calibration device has a number of advantages. For example, by having a permanent present this can allow timely measurement of reflection characteristics such as phase shift, increased accuracy may be achieved with a high density deployment of FSGs, measurement of reflection characteristics may be carried out whenever desired, and so on. However, the deployment FSGs incurs additional deployment cost and operational cost.

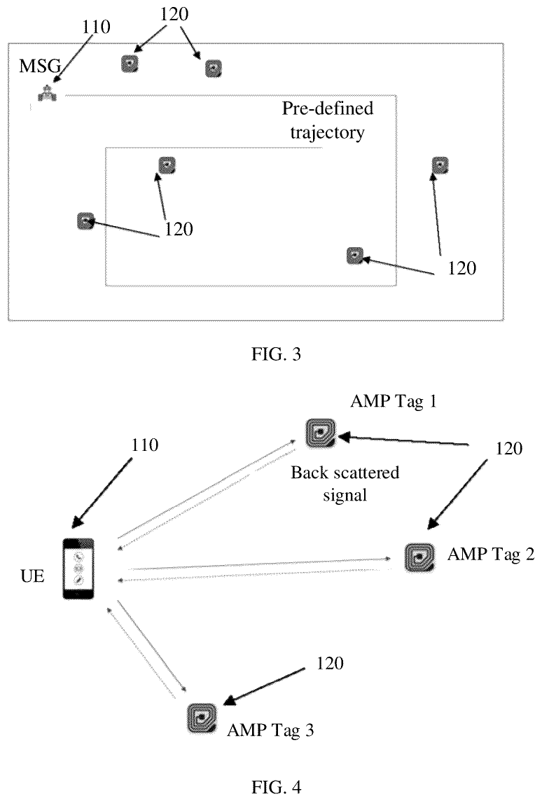

In the alternative embodiment of FIG. 3, a mobile signal generator (MSG) performs the role of the calibration device 110. Like the FSG, an MSG may also generate the same signal as the UE. However the MSG may move through a service area with a known position at any given time. For example, the MSG can move following pre-defined trajectory within the entire positioning service area as shown in FIG. 3.

The phase measurement and reporting procedure of MSG is similar to FSG except that the location of the MSG in the time of measurement should also be reported to the server 130. The location of MSG can be obtained based on the starting time, moving speed of MSG, knowledge of pre-defined trajectory and so on.

Compared with FSG, MSG may require a lower deployment cost since a single device may cover a broader area. For example, at one extreme, only one MSG can be used to traverse the entire service area to measure all AMP tags, although in other approaches it will be possible to provide multiple MSGs for a given area. However, as noted above, the MSG must report additional information, such as the location of MSG, during operation. It may also be that the calibration accuracy performance may be affected if the location of MSG is not accurately estimated at the time that a characteristic of the reflection is measured. Similarly, there is less flexibility to measure the reflection from a given locating element 120. In some circumstances the MSG may be impractical, for example it may not be easy for the MSG to traverse the area or the presence of the MSG may obstruct other users of the environment, such as people and vehicles. This may be particularly problematic during daytime.

In the example illustrated in FIG. 4, the calibration device 110 is implemented as a UE. A UE is mobile similar to the embodiment of FIG. 3, and for the same reasons it will be necessary to report its location to the server during the classification process. This may be done in a variety or ways, which may include locating the UE using the locating elements 120 themselves.

For example, due to the low cost of AMP tags, a high density deployment of such tags as locating elements 120 may be feasible. In such a case, many AMP tags can surround a UE. We can denote the AMP tags from which a UE can measure the characteristics of a reflection as a set χ={τ1, τ2, . . . , τN}, where N is the total number of surrounding AMP tags.

Given the substantial number of AMP tags in this example, the UE may not need to make use of all AMP tags for positioning. For example, only a subset of χ may be used to identify a location of the UE, this subset can be denoted as χ1. The remaining AMP tags that are not used can be denoted as another subset χ2, where χ={χ1, χ2}.

In one approach, once the location of the target UE is obtained using tags in subset χ1, it can be used to refine the understanding of the reflection characteristics of AMP tags in subset χ2. In order that this can be done with a high degree of confidence, preferably this process is only implemented when is very confident with the positioning accuracy of the target UE. For example, the signal strength from tags χ1 is sufficiently high, such as above a pre-defined threshold.

In another approach, once the location of the target UE is obtained, it can be used to measure reflection characteristics of newly deployed or relocated AMP tags. Alternatively, the server 130 may provide instructions to a UE that has been located to update the calibration of certain AMP tags.

In general, it is possible, in the embodiments of FIGS. 2 to 4 and in other implementations, for one locating element 120 (AMP tag) to be measured multiple times. This may be done by multiple calibration devices 110 (e.g. multiple FSG/MSG) and/or by the same calibration device at different times. When multiple measurements are used, the measured characteristics of the locating elements can be further processed, e.g., averaged or choosing the value with the higher confidence level. This processed characteristic can then be used to update the table in the server 130. Combinations of the approaches shown in FIGS. 2 to 4 (i.e. multiple calibrations devices of different kinds) may be used to optimise efficiency according to circumstances.

Embodiments of the present application provide a method for calibrating a positioning system, and the method includes:
transmitting a calibration signal from a calibration device at a first known location,
receiving, by the calibration device, a reflection of the calibration signal from a locating element at a second known location, where the reflection carries identification information of the locating element,
analysing, using the first known location and the second known location, a characteristic of the reflection to determine a reflective property of the locating element; and
storing calibration information comprising the reflective property of the locating element for use during a process for locating a user device.

In some embodiments, the reflective property is a phase shift.

In some embodiments, the reflective property is a reflection loss.

In some embodiments, the method further includes transmitting data indicating the characteristic of the reflection or the reflective property from the calibration device to a server, where storing the calibration information includes storing the calibration information at the server.

In some embodiments, storing the calibration information includes storing the calibration information locally at the calibration device.

In some embodiments, the calibration device is a fixed device.

In some embodiments, the calibration device is a mobile device.

In some embodiments, the calibration device is a user equipment, UE.

In some embodiments, the locating element is an ambient power tag.

In some embodiments, the method further includes determining a confidence level in the determined reflective property of the locating element.

In some embodiments, the confidence level is determined based on one or more of:
a signal strength of the reflection;
a signal strength difference between multiple reflections; and
a time at which the reflection is received.

Embodiments of the present application provide a method for locating a user device, and the method includes:
transmitting a locating signal from the user device to a plurality of locating elements, each having a known location;
receiving reflections of the locating signal from the locating elements at the user device, where each reflection of the locating signal carries identification information of the locating element from which it was reflected;
calculating distances between the user device and the locating elements based on characteristics of the reflections received from the locating elements and calibration information obtained through the method of any one of claims 1 to 11; and
identifying the location of the user device based on the calculated distances and the known locations.

In some embodiments, the step of identifying the location of the user device is carried out at the user device.

In some embodiments, the step of identifying the location of the user device is carried out at a server.

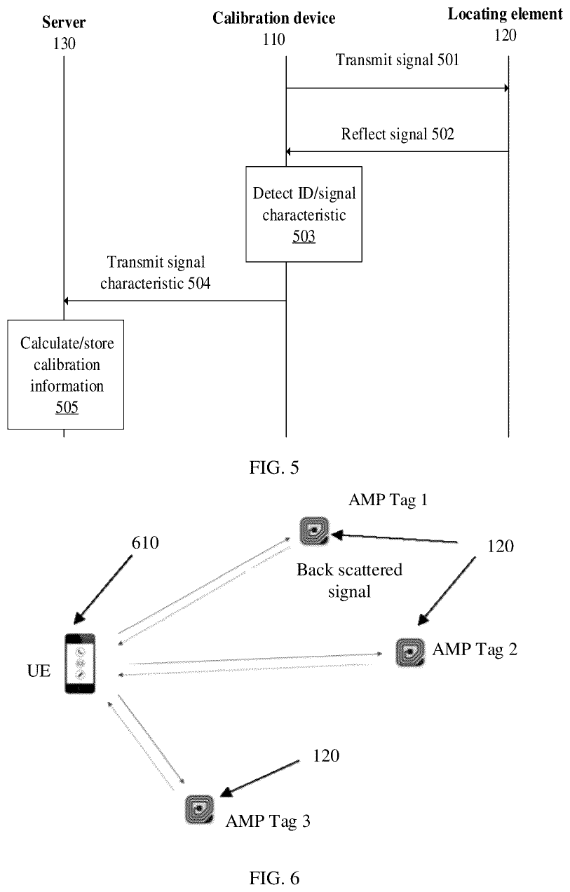

FIG. 5 illustrates a process of calibration that may be operated by the systems illustrated in FIGS. 1 to 4.

As step 501, the calibration device 110 (e.g. an FSG, MSG or UE) transmits calibration signals to the adjacent locating elements 110 (such as AMP tags). These signals may be of identical form to signals a UE (which may or may not be the calibration device 110) will use later to the purposes of positioning. For example, the calibration signals and later positioning signals may have the same waveform, signal structure, carrier frequency and so on.

At step 502, the calibration signals are reflected (backscattered) by the locating elements 120 to generate reflection signals. The reflection signals carry identification information allowing the locating element 110 from which they were reflected to be identified. For example, in some embodiments, the locating elements 120 (AMP tags) send their own ID via back scattering signal to the calibration device and the same part of the signal is also used for measuring a characteristic of the signal used in the calibration process (e.g. phase measurement).

However, in some cases, it is preferable to apply a technique to divide the reflection signal between the parts that carry the locating element 110 ID and that used for measuring the characteristic of the signal used during calibration. That is, it may be that the back scattering signal carrying AMP tag ID cannot be used for phase measurement, for example, it may be a non-continuous signal with on-off keying (OOK) modulation. In these circumstances, time division can be used, i.e., one time slot for back scattering signal carrying AMP tag ID and another time slot for back scattering signal phase measurement. Other modulation methods, such as frequency shift keying (FSK) might also be used in which case the same time division can be applied. In general, it may be desirable to separate the time for ID transmission and time for measurement of phase or any other characteristic of the reflection signal used for calibration purposes.

At step 503, the calibration device 110 detects the AMP tag ID in the backscattered/reflected signal and also measures a characteristic (such as phase) of the backscattered/reflected signals. Where multiple reflected signals are received either simultaneously over overlapping in time, the calibration device may be able to distinguish the signals from multiple AMP tags. For example, a time division multiplexing solution may be adopted in which the signals are multiplexed in time domain or frequency division multiplexing in which each AMP tag backscatters/reflects the incoming signal with different frequency shift. In general, any appropriate technique may be adopted by the skilled person for the purpose of distinguishing between reflected/backscattered signals.

At step 504, the calibration device 110 sends the ID and signal characteristic (for example, phase) information received in the backscattered signals from the locating elements 120 to the server 130 via wired/wireless links. The calibration device may also transmit information relating the calibration signal (for example. where the signal characteristic used for calibration relates to phase, information about the phase of the transmitted signal may also be provided). Where necessary, the calibration device 110 may also report its current location to the server 130.

At step 505, using the information received from the calibration device 110 and the location of the calibration device 110 (whether reported at step 504 or already known by the server 130, such as in the example of an FSG being used as calibration device 110) the server is able to calculate information relating to a reflective characteristic of the locating element 120. For example, the server 130 may calculate the phase shift θps,i induced by the backscattering/reflection of the calibration signal by the AMP tag and update the relevant AMP tag information vector {para 1=ID of AMP Tag i, para 2=θps,i, para 3, . . . } accordingly.

As described above, the calibration device 110 reports information about the reflected signal, from which the server 130 then derives a reflection characteristic of the locating element 120 itself. However, it should be noted that if the calibration device 110 itself stores the relevant information, it may itself infer the reflection characteristic from the received signal. For example, instead of reporting the measured phase at step 504, the calibration device 110 may report the phase shift directly if it is capable of calculating the shift value.

The server 130 acts as a central node and maintains a table containing all the AMP tag information vectors including the reflection characteristic (phase shift) measured in this way. This can then be utilised in future processes for locating a UE or other device as described below.

As noted above, it may be desirable to repeat the process of FIG. 5 at different points in time in order to maintain an optimum record of the reflection characteristics of the available locating elements. In the preferred embodiment, this may involve updating the AMP tag information vector table in a periodic or on-demand manner.

For example, in one approach, the information stored at the server (for example, the AMP tag information vector table) can be updated periodically by running the above procedure from time to time (for example, according to a predetermined schedule). Consequently, the AMP tag information vector table may be updated when new AMP tags are deployed, existing AMP tags are relocated, or the phase shift is changed due to a change of environment or the behaviour of an individual tag (for example, decay of the circuit). However, performing the process at a high frequency may meaningfully increase energy consumption at the AMP tags since the incoming signal needs to be backscattered with modulation periodically, and this may place a practical limit on the efficacy of periodic updates of this kind.

Alternatively, this procedure can be performed in on-demand manner. For example, it may be triggered by events such as: new AMP tag deployment, existing AMP tag relocation, a positioning error exceeding a certain threshold, and so on. Consequently, the calibration device 110 (and the locating elements 120) can usually stay dormant unless the server sends a trigger signal to the calibration device 110 to perform the process. Once calibration device 110 receives such a signal, it initiates the pre-measurement/calibration procedure and the table of AMP tag information vector can be updated. The energy consumption of an on-demand mode can be significantly lower than a periodic mode at high frequency. In some examples, a hybrid approach may be taken where relatively low frequency periodic calibration is supplemented by on-demand calibration for certain identified events.

According to the capability of the calibration device 110, it may also maintain a table of all adjacent AMP tags that need to be pre-measured/calibrated. This may be particularly appropriate where the calibration device is an FSG. With this table, the calibration device can compare the received IDs with the local table and only send the ID and phase information of the newly deployed or relocated AMP tags.

A timestamp indicating the time at which the reflected signal was observed can also be sent with the ID and information about the signal (for example, phase information) by calibration device 110 at step 504. This timestamp can be used to evaluate if the current information about the signal is out of date and new measurement needs to be performed.

Another optional parameter to be reported by the FSG is the confidence level of the measurement, which can either be a continuous value or discrete values within a certain range, indicating how reliable the phase measurement is. It may be that the calibration information for a particular locating element is only updated in a threshold value for this confidence level is met. This confidence level is associated with each measurement or each AMP tag and can be determined based on one or more of the following criteria:
1) Back scattering signal strength and the higher the strength, the higher the confidence level is;
2) The signal strength difference between the strongest path and the average strength of all detected paths in case of multipath. The larger the difference, the more likely the strongest path is the line-of-sight (LOS) path thus the higher the confidence level is; and
3) Measurement timing. It may be one can infer that environmental conditions are more suited to confident measurements at different times of day. For example, in a public space a night time confidence level is higher than daytime confidence since LOS link is more likely during night without a crowd of people obstructing the LOS links.

With the server 130 in possession of the relevant calibration information relating to the reflection characteristics of the locating elements, this information may then be used in a process for locating a user device. For example, consider the scenario of FIG. 6, in which a user device 610 is in the proximity of a plurality of locating elements 120. The locating elements 120 of FIG. 6 are the same as the locating elements described above, while the user device 610 may be a different device or may be, for example, the UE 110 described in the context of FIG. 4 (that is, user device 610 may be the calibration device 110). In any case, the user device 610 may have access to the server 130 via a wired or wireless network.

In general the user device 610 may be a terminal device such as a user equipment (UE), an access terminal, a subscriber unit, a subscriber station, a mobile station, a remote station, a remote terminal, a mobile device, a user terminal, a terminal, a wireless communication device, a user agent, or a user apparatus. However, the embodiments of the present application are not limited thereto. The user device 610 may coupled to a cellular network, through which it may communicate with the server 140.

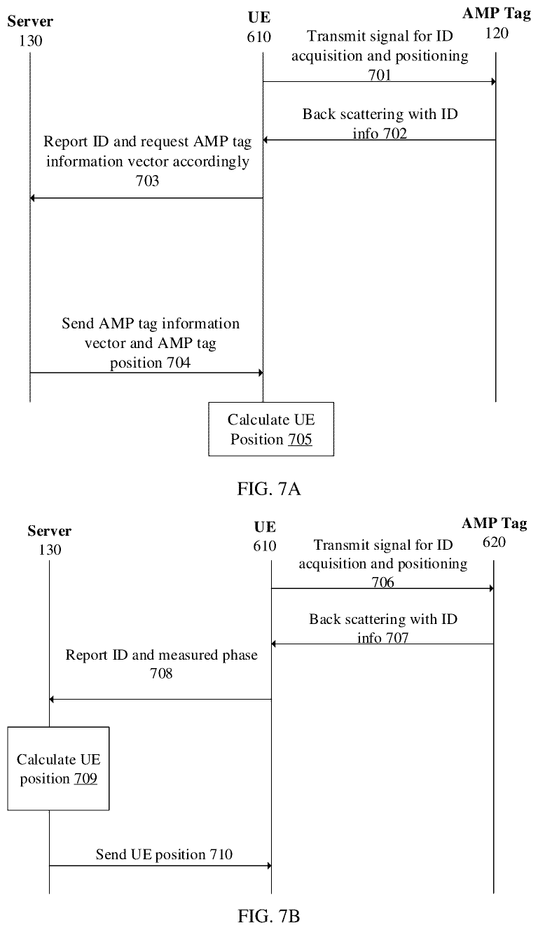

FIGS. 7A and 7B show example processes for locating the user device 610 using the calibration information obtained through the method of FIG. 5.

FIG. 7A shows user device 610 based positioning. In this case, the user device (for example, UE) issues a locating signal at step 701 which is backscattered/reflected by the locating elements 120 in its vicinity and received at step 702. As described above, during backscattering identification information of each locating element is imparted into the signal.

At step 703, the user device 610 reports the observed identification information and requests the calibration information associated with that ID (for example, in the form of the relevant AMP tag information vector) from the server 130. This information together with the known positions of the relevant locating elements is sent by the server 130 to the user device 610 at step 704.

The user device 610 may then calculate its position from the known locations of the locating elements from which reflected signals have been received, together with one or more measured characteristics of those signals (such as phase). Moreover, with an understanding of the effect of the reflection process on the measured characteristics obtained from the calibration information, the accuracy of the calculated location can be improved.

The approach of FIG. 7B differs from that of FIG. 7A in that the calculation of UE position is carried out at the server 130. The initial part of the process is similar to that of FIG. 7A with steps 706 and 707 mirroring steps 701 and 702. That is, the user device (for example, UE) issues a locating signal at step 706 which is backscattered/reflected by the locating elements 120 in its vicinity and received at step 707. As described above, during backscattering identification information of each locating element is imparted into the signal.

A characteristic of the received reflected signals (such as the measured phase) can then be calculated by the user device 610 and reported to the server 130 together with the identification information at step 708.

Then user device 610 position is calculated at the server based on calibration information held there (for example, based on the table of AMP tag information vectors) at step 709 and reported to the user device 610 at step 710. It may be that the user device 610 encounters newly deployed or relocated AMP tags/other locating elements 120 that have not been pre-measured/calibrated and thus for which no relevant calibration information is held by the server 130. In such a case, these locating elements 120 should be eliminated when calculating UE's position.

While the above disclosure is focused on carrier-phase based positioning, the same procedures can also be applied to other positioning methods to remove the ambiguity of initial state. For example, for signal strength based positioning, phase shift θps,I can be replaced with reflection loss and the same procedure can be applied. Moreover, it can be that combinations of reflective properties can be calibrated either simultaneously or in sequence with such combinations being used when locating a user device.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combine in various ways. All possible combination and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can”, “could”, “might”, or “may” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in a way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modification may be made to the above-describe embodiments, the elements of which are to be understood as being among other acceptable examples. All such modifications and variations are intended to be included herein within the scope of this disclosure. The foregoing description details certain embodiments of the disclosure. It will be appreciated, however, that no matter how detailed the foregoing appears in text, the concept can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the disclosure with which that terminology is associated. The scope of the protection should therefore be construed in accordance with the appended claims and equivalents thereof.

What is claimed is:

1. A method for calibrating a positioning system, comprising
transmitting a calibration signal from a calibration device at a first known location,
receiving, by the calibration device, a reflection of the calibration signal from a locating element at a second known location, wherein the reflection carries identification information (ID) of the locating element,
analysing, using the first known location and the second known location, a characteristic of the reflection to determine a reflective property of the locating element; and
storing calibration information comprising the reflective property of the locating element for use during a process for locating a user device.

2. The method according to claim 1, wherein the ID of the locating element is sent to the calibration device via a back scattering signal, and a same part of the back scattering signal is further used for measuring a phase of a signal used in a calibration process.

3. The method according to claim 1, wherein the reflective property is a phase shift or a reflection loss.

4. The method according to claim 1, further comprising transmitting data indicating the characteristic of the reflection or the reflective property from the calibration device to a server, wherein storing the calibration information comprises storing the calibration information at the server.

5. The method according to claim 4, wherein transmitting the data indicating the characteristic of the reflection or the reflective property from the calibration device to the server comprises:
transmitting the following to the server: a timestamp indicating a time at which a reflected signal was observed by the calibration device, the ID of the locating element, and phase information of the reflected signal.

6. The method according to claim 1, wherein storing the calibration information comprises storing the calibration information locally at the calibration device.

7. The method according to claim 1, wherein the calibration device is a fixed device; or
the calibration device is a mobile device; or
the calibration device is a user equipment (UE).

8. The method according to claim 1, wherein the locating element is an ambient power tag.

9. The method according to claim 1, further comprising determining a confidence level in the determined reflective property of the locating element;
wherein the confidence level is determined based on one or more of:
a signal strength of the reflection;
a signal strength difference between multiple reflections; and
a time at which the reflection is received.

10. A calibration system comprising a calibration device at a first known location and a locating element at a second location, wherein the system is configured to:
transmit a calibration signal from the calibration device,
receive, by the calibration device, a reflection of the calibration signal from a locating element, wherein the reflection carries identification information (ID) of the locating element,
analyse, using the first known location and the second known location, a characteristic of the reflection to determine a reflective property of the locating element; and
store calibration information comprising the reflective property of the locating element for use during a process for locating a user device.

11. The calibration system according to claim 10, wherein the ID of the locating element is sent to the calibration device via a back scattering signal, and a same part of the back scattering signal is further used for measuring a phase of a signal used in a calibration process.

12. The calibration system according to claim 10, wherein the reflective property is a phase shift or a reflection loss.

13. The calibration system according to claim 10, further comprising a server, wherein the calibration device is configured to transmit data indicating the characteristic of the reflection or the reflective property to the server, and the calibration information is stored at the server or is stored locally at the calibration device.

14. The calibration system according to claim 13, wherein the calibration device is configured to transmit the following to the server:
a timestamp indicating a time at which a reflected signal was observed by the calibration device, the ID of the locating element, and phase information of the reflected signal.

15. The calibration system according to claim 10, wherein the calibration device is a fixed device; or
the calibration device is a mobile device; or
the calibration device is a user equipment (UE).

16. The calibration system according to claim 10, wherein the locating element is an ambient power tag or a radio-frequency identification tag.

17. The calibration system according to claim 10, further configured to determine a confidence level in the determined reflective property of the locating element;
wherein the confidence level is determined based on one or more of:
a signal strength of the reflection;
a signal strength difference between multiple reflections; and
a time at which the reflection is received.

18. A positioning system for locating a user device, comprising a user device and a plurality of locating elements comprising a locating element at a second location of a calibration system, wherein the positioning system is configured to:
transmit a locating signal from the user device to the plurality of locating elements, each having a known location;
receive reflections of the locating signal from the locating elements at the user device, wherein each reflection of the locating signal carries identification information of the locating element from which it was reflected;
calculate distances between the user device and the locating elements based on characteristics of the reflections received from the locating elements and calibration information of characteristics of the reflections received from the locating elements stored by the calibration system; and
identify the location of the user device based on the calculated distances and the known locations;
wherein the calibration system further comprises a calibration device at a first known location, and the calibration system is configured to:
transmit a calibration signal from the calibration device,
receive, by the calibration device, a reflection of the calibration signal from a locating element at a second known location, wherein the reflection carries identification information (ID) of the locating element,
analyse, using the first known location and the second known location, a characteristic of the reflection to determine a reflective property of the locating element; and
store calibration information comprising the reflective property of the locating element for use during a process for locating a user device.

19. The positioning system according to claim 18, configured to identify the location of the user device at the user device.

20. The positioning system according to claim 18, configured to identify the location of the user device at a server.
